(19) United States
(12) Patent Application Publication
(10) Pub. No.: US 2006/0110489 A1
(43) Pub. Date: May 25, 2006

(54) Apparatus for measuring separation of mold parts

(76) Inventor: Richard T. Seaver, Montague, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/282,236

(22) Filed: Nov. 18, 2005

Related U.S. Application Data
(60) Provisional application No. 60/631,064, filed on Nov. 24, 2004.

(51) Int. Cl. B29C 47/92

(52) U.S. Cl. 425/150

(57) ABSTRACT

A probe for plastic injection molds and the like measures the separation between mold parts due to pressurization of the molten plastic in the mold cavity. The probe may be connected to a system controller to halt the injection process if excessive separation is detected to thereby prevent damage to the molding apparatus. The mold set-up and/or design may be modified to prevent separation between the mold parts, thereby eliminating flash and potential damage to the molding apparatus. A computer may be coupled to the probe to store, process and display information from the probe concerning separation of the mold parts.

### CROSS-REFERENCE TO RELATED APPLICATION

The present application claims the benefit of U.S. Provisional Application No. 60/631,064, filed on Nov. 24, 2004, the entire contents of which is hereby incorporated by reference.

### BACKGROUND OF THE INVENTION

Injection molding has been widely used to fabricate various parts. During the injection molding process, molten polymer material is injected into a mold cavity that is generally formed by two mold halves that are clamped together. The pressure on the material in the mold cavity tends to push the mold halves apart at the parting line. This separation of the mold halves can cause the parts to have undesirable or unacceptable flashing. Also, the separation of the mold halves may cause substantial damage to the tooling.

### SUMMARY OF THE INVENTION

One aspect of the present invention is an injection mold apparatus having mold parts with mold surfaces forming a mold cavity when the mold parts are in a closed position. The mold parts define adjacent surfaces forming a part line when in the closed position. The injection mold apparatus includes a probe configured to determine the separation, if any, between the contact surfaces of the mold parts.

Another aspect of the present invention is a method of injection molding parts in a mold apparatus having mold parts with mold surfaces forming a mold cavity when the mold parts are in a closed position. The mold parts define adjacent surfaces forming a part line when in the closed position. The method includes providing a probe adapted to sense the separation, if any, between the mold parts. The method further includes controlling the molding process based, at least in part, on information concerning the separation between the mold parts obtained from the probe.

### BRIEF DESCRIPTION OF THE DRAWINGS

FIG. 1 is a partially schematic elevational view of an injection molding machine including a measuring apparatus or device according to the present invention.

### DETAILED DESCRIPTION OF PREFERRED EMBODIMENT

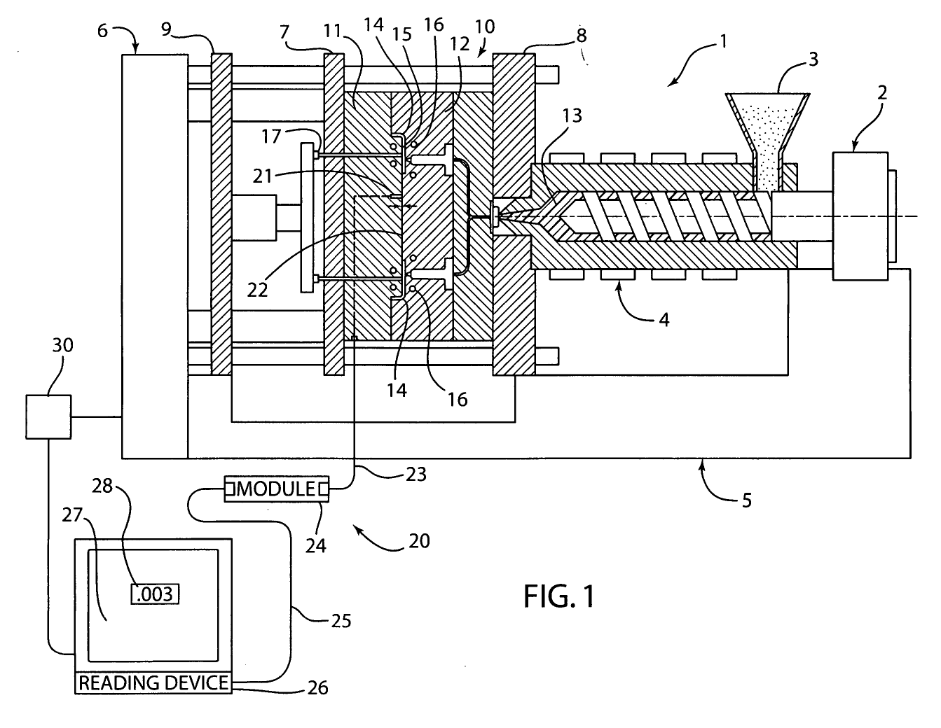

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

An injection molding machine 1 includes a reciprocating screw/hydraulic drive 2, a hopper 3, and heater bands 4 that are supported by a base 5. A clamping mechanism 6 is operably connected to a moving platen 7. A forward platen 8 and rear platen 9 are stationary. Mold 10 includes a first half 11 that is secured to the moving platen 7, and a second half 12 that is secured to the stationary platen 8.

During operation, the molten plastic material 13 is injected into mold cavity 14 under pressure to form parts 15. Coolant flowing through cooling lines 16 provides for cooling of the parts 15. After the parts 15 are formed, platen 7 is shifted toward rear platen 9, and ejector pins 17 contact rear platen 9 to eject the parts 15 from the mold.

A measuring apparatus 20 according to one aspect of the present invention includes a probe 21 that is positioned to measure any separation that may occur along parting line 22 where the mold halves 11 and 12 contact one another. A communications line 23 connects the probe 21 to a module 24, and a second communications line 25 connects the module 24 to a reading device such as a laptop computer 26 having a display screen 27. Probe 21 may comprise a mechanical or electrical measuring device or the like, or any other device or sensor capable of determining if separation has occurred between the mold halves 11 and 12. In the illustrated example, probe 21 comprises a BBP315020 Ultra High Precision LVDT Gaging Probe, available from Macro Sensors™ of Pennsauken, New Jersey. This probe's repeatability is 0.000006 inches, thereby providing very precise measurement of mold separation. Measuring device or probe 21 provides a measurement of the amount of separation between the first and second mold halves 11 and 12 at the location of the measuring device 21. If the mold halves 11 and 12 separate, such separation is typically greatest directly adjacent the mold cavity 14 due to the pressure acting in mold cavity 14. Accordingly, measuring device or probe 21 may be positioned at the parting line 22 directly adjacent the mold cavity 14 to determine if separation has occurred. The measuring device 21 generates a signal to the module 24. Module 24 converts the signal from the measuring device 21 into a format that permits further processing by the computer 26. In the illustrated example, module 24 provides a signal to the laptop 26, and laptop 26 utilizes a commercially available spreadsheet software program to generate a digital readout 28 of the separation (if any) in inches.

Measuring device 20 can be utilized during initial setup of injection molding machine 1 prior to a production run of parts. The mold halves 11 and 12 are initially brought together, and the distance (i.e., readout 28) is set to zero. As the molten plastic 13 is injected, the separation is monitored utilizing digital readout 28. The amount of allowable separation will vary upon the particular application. If, for example, it is determined that no more than 0.003 inches of separation should be allowed, the injection process can be halted to prevent damage if a reading of 0.003 inches or greater is detected. If the separation between the mold halves 11 and 12 exceeds (or approaches) the allowable amount of separation, the process and/or tooling may be modified to reduce the separation thereby prevent damage to the tooling and production of defective parts having flashing. For example, a clamping mechanism 6 having a larger force capability may be utilized to prevent separation. Also, the sequence of opening of the gates leading to the mold cavity may be modified to change the pressure and/or pressure distribution in the mold cavity. Still further, the location and/or configuration of the gate may be modified. Because the separation can be determined prior to start of production run, damage to the tooling and production of defective parts and associated costs that would otherwise occur can be eliminated.

The computer 26 can also be utilized to monitor the separation between mold halves 11 and 12 during the production run. Computer 26 can input the separation information into a commercially available spreadsheet software program that provides a complete record of the mold separation for each part produced in the production run. In this way, excessive separation due to production variables or the like can be detected before damage to the tooling occurs. Furthermore, the computer 26 may be operably connected to a system controller 30. System controller 30 is utilized to control the injection molding machine 1 and/or other related components. The computer 26 and controller 30 may be configured to stop or modify the injection molding process to alleviate or eliminate separation measured by the measuring apparatus 20.

The measuring apparatus of the present invention may be utilized for a wide variety of molding operations wherein a molten material is injected into a mold cavity under pressure. For example, although the measuring device has heretofore been described in conjunction with a plastic injection molding process, it will be readily understood that the measuring device may be utilized in conjunction with metal die cast machinery and processes and the like, or other processes wherein a molten material is molded under pressure. Also, it will be readily understood that a wide variety of sensors or devices or the like may be utilized to determine if separation between the mold halves has occurred.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. In an injection mold apparatus having mold parts having mold surfaces forming a mold cavity when the mold parts are in a closed position, therein the mold parts define adjacent surfaces forming a part line when in the closed position, the improvement comprising:
a probe configured to determine the separation, if any, between the adjacent surfaces of the mold parts.

2. The injection mold apparatus of claim 1, including:
a processor;
a display screen coupled to the processor; and wherein:
the probe is operably coupled to the processor and sends a signal to the processor to provide a visual display of the separation between the mold parts.

3. The injection mold apparatus of claim 2, wherein:
the processor stores data corresponding to a plurality of mold separations for a plurality of parts molded in the mold cavity.

4. The injection mold apparatus of claim 1, wherein:
the probe comprises an electrical measuring device.

5. The injection mold apparatus of claim 1, wherein:
the probe is positioned directly adjacent the mold cavity.

6. The injection mold apparatus of claim 1, wherein:
the probe is positioned at the part line.

7. The injection mold apparatus of claim 1, including:
an injection molding machine having a clamping mechanism in which the mold parts are mounted and a drive mechanism configured to drive molten plastic into the mold cavity;
a controller coupled to the injection molding machine;
a programmable computer coupled to the probe, wherein the computer is programmed to send a signal to the controller based, at least in part, on a signal the computer receives from the probe.

8. The injection mold apparatus of claim 7, wherein:
the computer interrupts the molding process if the probe generates a signal indicative of a preselected separation between the mold parts.

9. The injection mold apparatus of claim 7, wherein:
the computer includes a spreadsheet program configured to process data from the probe.

10. A method of injection molding parts in a mold apparatus having mold surfaces forming a mold cavity when the mold parts are in a closed position, therein the mold parts define adjacent surfaces forming a part line when in the closed position, the method comprising:
providing a probe adapted to sense the separation, if any, between the mold parts;
controlling the molding process based, at least in part, on information concerning separation between the mold parts obtained from the probe.

11. The method of claim 10, wherein:
controlling the molding process includes halting the injection molding process if the mold parts separate more than a predetermined allowable amount.

12. The method of claim 10, wherein:
the mold cavity is fluidly connected to a plurality of openable gates; and
a sequence of opening of the gates is determined from information from the probe.

13. The method of claim 10, including:
providing a display screen; and
displaying information from the probe on the display screen.

14. The method of claim 13, including:
storing information from the probe corresponding to a plurality of parts molded in the mold cavity.

15. The method of claim 10, including:
moving the mold parts to the closed position without injecting plastic material into the mold cavity to mold a part;
setting the probe to a zero setting indicative of no separation between the mold parts.

16. The method of claim 10, wherein:
the mold apparatus includes a controller, and including:
providing a computer coupled to the controller;
configuring the computer to generate a signal to the controller based, at least in part, on a signal from the probe.

17. The method of claim 16, including:
storing information from the probe in the computer.
